(19) United States
(12) Patent Application Publication
(10) Pub. No.: US 2010/0090119 A1
(43) Pub. Date: Apr. 15, 2010

(54) Radiation imaging apparatus

(75) Inventor: Masaru Sato, Kanagawa-ken (JP)

Correspondence Address: AKERMAN SENTERFITT, 8100 BOONE BOULEVARD, SUITE 700, VIENNA, VA, 22182-2683, US

(73) Assignee: FUJIFILM Corporation, Tokyo (JP)

(21) Appl. No.: 12/588,446

(22) Filed: Oct. 15, 2009

(30) Foreign Application Priority Data
Oct. 15, 2008 (JP) 2008-266069

(51) Int. Cl. G01T 1/24

(52) U.S. Cl. 250/370.08

(57) ABSTRACT

A radiation imaging apparatus has a built in solid state detector. A detector holder for holding the solid state detector is configured to be movable within a casing from an imaging position and a standby position away from the imaging position, in order to enable effective utilization of equipment within the apparatus, such as a grid and an AEC, during imaging using cassettes. The apparatus is configured to accept insertion of a radiation imaging cassette having a built in radiation image detecting means when the detector holder is at the standby position.

### BACKGROUND OF THE INVENTION

1. Field of the Invention

The present invention is related to a radiation imaging apparatus having a solid state detector, for recording radiation images of subjects as electrostatic latent images by receiving irradiation of radiation which has passed through the subjects, housed within a casing.

2. Description of the Related Art

Presently, various radiation imaging apparatuses, for obtaining radiation images to be utilized for medical diagnoses and the like, have been proposed and are in practical use. These radiation imaging apparatuses employ solid state detectors (having semiconductors as main components thereof) as radiation image detecting means. The solid state detectors detect radiation that has passed through subjects, and obtain image signals that represent radiation images of the subject.

A variety of formats have been proposed for the solid state detectors to be utilized in these apparatuses. Regarding a charge generating process for converting radiation to electrical charges, there are solid state detectors of a light conversion type, and solid state detectors of a direct conversion type, for example. A solid state detector of the light conversion type temporarily stores signal charges, obtained at a photoconductive layer by detecting fluorescence emitted by phosphors due to irradiation with radiation, in a charge accumulating section, then converts the accumulated charges to image signals (electrical signals) and outputs the image signals. The direct conversion type of solid state detector temporarily stores signal charges, generated within a photoconductive layer due to irradiation with radiation and collected by a charge collecting electrode, in a charge accumulating section, then converts the accumulated charges to electric signals and outputs the electric signals. In this type of solid state detector, the main components are the photoconductive layer and the charge collecting electrode.

Regarding a charge readout process for reading out the accumulated charges, there are an optical readout method and an electrical readout method. In the optical readout method, accumulated charges are read out by irradiating a solid state detector with readout light (electromagnetic waves for readout). In the electrical readout method, accumulated charges are read out by scanning TFT's (thin film transistors), a CCD (charge coupled device), or a CMOS (complementary metal oxide semiconductor) sensor, which are connected to a charge accumulating section. The TFT readout method is disclosed in U.S. Pat. No. 6,828,539.

An improved direct conversion type solid state detector has also been proposed in U.S. Pat. No. 6,268,614. The improved direct conversion type solid state detector is a solid state detector of the direct conversion type that utilizes the optical readout method. This solid state detector comprises: a recording photoconductive layer that exhibits photoconductivity when irradiated by recording light (radiation, or fluorescence generated by the irradiation of radiation); a charge transport layer that acts substantially as an insulator with respect to charges having the same polarity as latent image charges, and that acts substantially as a conductor with respect to charges having the opposite polarity as latent image charges; and a readout photoconductive layer that exhibits photoconductivity when irradiated by electromagnetic waves for readout; stacked in this order. Signal charges (latent image charges) that bear image information are accumulated at an interface (charge accumulating section) between the recording photoconductive layer and the charge transport layer. Electrodes (a first conductive layer and a second conductive layer) are provided on both sides of the three aforementioned layers. In the solid state detector having this format, the recording photoconductive layer, the charge transport layer, and the readout photoconductive layer are the main components.

In the case that a radiation imaging apparatus having a built in solid state detector such as those described above is installed, there are cases in which it is desired to perform radiation imaging with a different means, such as an imaging plate, utilizing only the imaging stage of the apparatus and not the solid state detector of the apparatus. Conventionally, imaging was performed with radiation imaging cassettes having built in radiation image detecting means being mounted in external holders outside the imaging stage in these cases. However, in this configuration, equipment within the apparatus, such as a grid and an AEC, could not be utilized during imaging using cassettes. Therefore, it was difficult to improve the image quality and safety during imaging using cassettes.

Accordingly, there is demand for a radiation imaging apparatus with a built in solid state detector that enable effective utilization of equipment within the apparatus, such as a grid and an AEC, during imaging using cassettes.

### SUMMARY OF THE INVENTION

The present invention has been developed in view of the foregoing circumstances. It is an object of the present invention to provide a radiation imaging apparatus with a built in solid state detector that enable effective utilization of equipment within the apparatus, such as a grid and an AEC, during imaging using cassettes.

A radiation imaging apparatus of the present invention comprises:

a casing; and

a solid state detector, for recording radiation images of subjects as electrostatic latent images by receiving irradiation of radiation which has passed through the subjects, housed in a predetermined imaging position within the casing;

the solid state detector being held within the casing so as to be movable from the imaging position to a standby position away from the imaging position; and

the casing being configured to be capable of accepting insertion of a radiation imaging cassette having a radiation image detecting means that obtains radiation images of subjects as by receiving irradiation of radiation which has passed through the subjects at the imaging position, when the solid state detector is at the standby position.

Here, the “solid state detector” refers to a detector that converts radiation to electric charges either directly or after converting the radiation to light, then outputs the electric charges to the exterior, to obtain image signals that represent radiation images of subjects.

The solid state detector may be of any of a variety of formats. Regarding a charge generating process for converting radiation to electrical charges, there are solid state detectors of a light conversion type, and solid state detectors of a direct conversion type, for example. A solid state detector of the light conversion type temporarily stores signal charges, obtained at a photoconductive layer by detecting fluorescence emitted by phosphors due to irradiation with radiation, in a charge accumulating section, then converts the accumulated charges to image signals (electrical signals) and outputs the image signals. The direct conversion type of solid state detector temporarily stores signal charges, generated within a photoconductive layer due to irradiation with radiation and collected by a charge collecting electrode, in a charge accumulating section, then converts the accumulated charges to electric signals and outputs the electric signals. Regarding a charge readout process for reading out the accumulated charges, there are an optical readout method and an electrical readout method. In the optical readout method, accumulated charges are read out by irradiating a solid state detector with readout light (electromagnetic waves for readout). In the electrical readout method, accumulated charges are read out by scanning TFT's (thin film transistors), a CCD (charge coupled device), or a CMOS (complementary metal oxide semiconductor) sensor, which are connected to a charge accumulating section. Further, the solid state detector may employ the improved direct conversion method disclosed in U.S. Pat. No. 6,268,614.

The radiation image detecting means which is built in to the radiation imaging cassette may be any device, such as a solid state detector of any of the types described above, and an imaging plate.

In the radiation imaging apparatus of the present invention, it is preferable for the solid state detector to be configured to move so as to separate from a radiation incident surface of the casing to move from the imaging position to the standby position.

According to the radiation imaging apparatus of the present invention, the solid state detector is held within the casing so as to be movable from an imaging position and a standby position away from the imaging position. In addition, the casing is configured to be able to accept insertion of the radiation imaging cassette having the built in radiation image detecting means. Therefore, equipment within the apparatus, such as a grid and an AEC, can be employed even in cases that radiation imaging is performed with a different means, such as an imaging plate, utilizing only the imaging stage of the apparatus, without using the solid state detector of the apparatus.

A configuration may be adopted, wherein the solid state detector is moved from the imaging position to the standby position by being moved away from the radiation incident surface of the casing. In this case, the amount of movement of the solid state detector, when it is moved to create a space within the casing into which the radiation imaging cassette is to be inserted, can be suppressed.

### BRIEF DESCRIPTION OF THE DRAWINGS

FIG. 1 is a side view that illustrates a radiation imaging system of the present invention is employed.

FIG. 2A is a schematic diagram that illustrates a radiation imaging apparatus of the system of FIG. 1, with a detector in an imaging position.

FIG. 2B is a schematic diagram that illustrates the radiation imaging apparatus of the system of FIG. 1, with the detector in a standby position.

FIG. 3 is a schematic view that illustrates the construction of a solid state detector which is employed in the radiation imaging apparatus of FIGS. 2A and 2B.

### DESCRIPTION OF THE PREFERRED EMBODIMENTS

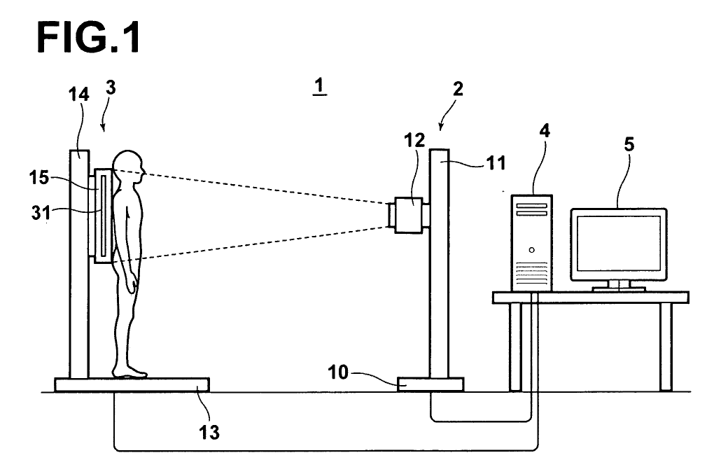

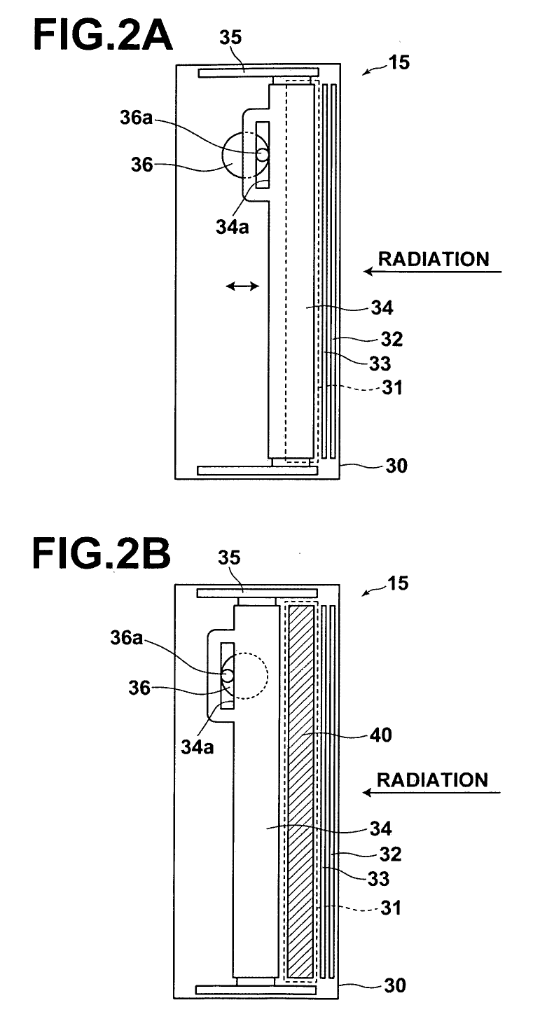

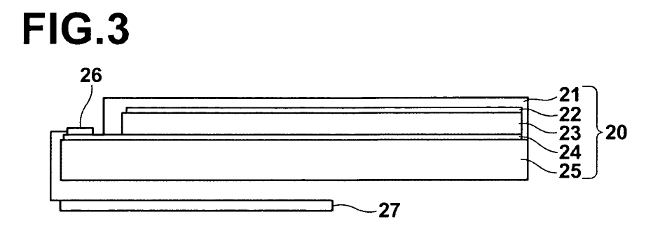

Hereinafter, an embodiment of the present invention will be described in detail with reference to the attached drawings. FIG. 1 is a side view that illustrates a radiation imaging system 1, in which a preferred embodiment of the present invention is employed. FIG. 2A and FIG. 2B are schematic diagrams that illustrate the construction of a radiation imaging apparatus of the system of FIG. 1. FIG. 3 is a schematic view that illustrates the construction of a solid state detector 20 which is employed in the radiation imaging apparatus of FIGS. 2A and 2B.

The radiation imaging system 1 is constituted by: a radiation irradiating apparatus 2 equipped with a radiation source or the like; a radiation imaging apparatus 3 equipped with the solid state detector 20 for detecting radiation; a computer 4, which is connected to the radiation irradiating apparatus 2 and the radiation imaging apparatus 3; and a monitor 5 which is connected to the computer 4.

The radiation irradiating apparatus 2 is constituted by: a base 10; a support column 11 which is fixed on the base 10; and a radiation irradiating section 12 which has a radiation source housed therein. The radiation irradiating section 12 is mounted onto the support column 11 so as to be movable along the longitudinal direction thereof (the vertical direction in FIG. 1).

In the radiation irradiating apparatus 2, the operations of the radiation source, the movement of the radiation irradiating section 12, and the like are controlled by a control means (not shown).

The radiation imaging apparatus 3 is constituted by: a base 13; a support column 14 which is fixed on the base 13; and a radiation imaging section 15 which has the solid state detector 20 housed therein. The radiation imaging section 15 is mounted onto the support column 14 so as to be movable along the longitudinal direction thereof (the vertical direction in FIG. 1).

Here, the construction of the radiation imaging section 15 will be described in detail with reference to the drawings. FIG. 2A and FIG. 2B are schematic diagrams that illustrate the construction of the radiation imaging apparatus 3. FIG. 2A illustrates a state in which a detector holder that holds the solid state detector 20 is in an imaging position. FIG. 2B illustrates a state in which a detector holder that holds the solid state detector 20 is in a standby position. Note that here, a description will be given with a radiation incident surface of a casing of the radiation imaging section 15 being designated as the front surface, and the opposite surface being designated as the rear surface.

As illustrated in FIG. 2A, the radiation imaging section 15 is constituted by: a casing 30; a grid 32 for removing scattered rays of radiation irradiated by the radiation source; an AEC 33 for detecting the dosage of radiation irradiated by the radiation source; the solid state detector 20; and a detector holder 34 that holds the solid state detector 20 therein. The grid 32, the AEC 33, the solid state detector 20, and the detector holder 34 are provided in the casing 30. In addition, a cassette insertion opening 31, through which a radiation imaging cassette to be described later is to be inserted, is provided in a side surface of the casing 30.

The detector holder 34 is configured so as to be movable in the horizontal direction of FIGS. 2A and 2B along two rails 35 which are mounted on the upper surface and the lower surface of the interior of the casing 30. The detector holder 34 is moved by a cam 36.

The cam 36 is equipped a circular rotating surface that rotates with the center of the surface as the axis of rotation. The cam 36 is also equipped with a cam shaft 36a which is provided on the rotating surface at a position away from the center thereof. A slot 34a, into which the cam shaft 36a is inserted and in which the cam shaft 36a slides accompanying rotation of the cam 36, is provided toward the rear surface of the detector holder 34.

As illustrated in FIG. 2A, when the cam shaft 36a of the cam 36 is at the three o'clock position, the detector holder 34 is at a position close to the front surface (radiation incident surface). This position is the imaging position. If the cam 36 is rotated 180° from this state, the cam shaft 36a of the cam 36 moves to the 9 o'clock position as illustrated in FIG. 2B, and the detector holder 34 is at a position close to the rear surface. This position is the standby position.

In the case that the detector holder 34 is at the standby position, a space is generated at the imaging position between the AEC 33 and the front surface of the detector holder 34. The cassette insertion opening 31 is provided to correspond to this space.

It becomes possible to insert a radiation imaging cassette 40 into the imaging position through the cassette insertion opening 31 when the detector holder 34 is at the standby position.

The solid state detector 20 which is held in the detector holder 34 is provided such that a radiation detecting surface thereof is parallel to the radiation incident surface of the radiation imaging section 15.

As illustrated in FIG. 3. The solid state detector 20 is constituted by: a glass substrate 25; a first conductive layer 24 formed by a-Si TFT's; a photoconductive layer 23 that generates electric charges and exhibits conductivity by receiving irradiation of radiation; a second conductive layer 22, and an insulating layer 21. The first conductive layer 24, the photoconductive layer 23, the second conductive layer 22, and the insulating layer 21 are formed on the glass substrate 25 in this order.

TFT's are formed in the first conductive layer 24 so as to correspond to each pixel. The output of each TFT is connected to an IC chip 26. The IC chip 26 is connected to an image signal processing section (not shown), which is printed on a printed circuit board 27.

The solid state detector 20 operates in the following manner.

An electric field is formed between the first conductive layer 24 and the second conductive layer 22. If radiation is irradiated onto the photoconductive layer 23 at this time, charge pairs are generated within the photoconductive layer. 23. Latent image charges corresponding to the amount of charge pairs are accumulated within the first conductive layer 24. When reading out the accumulated latent image charges, the TFT's of the first conductive layer 24 are sequentially driven to read out analog signals corresponding to the latent image charges corresponding to each pixel. The analog signals for each pixel are detected by the image signal processing section, and composed in the arrangement order of the pixels. The composed analog signals are converted into digital image signals by an A/D converter (not shown). The generated digital image signals are output from the image signal processing section to the computer 4 via a memory.

In the radiation imaging apparatus 3, the operation of the solid state detector 20, the rotating operation of the cam 36, the movement of the radiation imaging section 15, and the like are controlled by the control means (not shown).

The computer 4 functions as the control means that controls the radiation irradiating apparatus 2 and the radiation imaging apparatus 3. In addition, the computer 4 functions to record and manage data regarding patients who are subjects of imaging, such as names and sex, and data regarding imaging operations, such as portions to be imaged, radiation dosages, and procedures.

Next, the operation of the radiation imaging system 1 having the above configuration will be described.

First, a case will be described in which the detector holder 34 is in the imaging position. That is, a case will be described in which imaging is performed using the solid state detector 20 within the radiation imaging apparatus 3.

An operator causes a subject to stand at a position facing the radiation imaging apparatus 3. Then, the intensity and irradiation time of radiation is specified and an irradiation switch is depressed, to initiate imaging. This switch is depressed until the entire imaging operation is completed. The system is configured such that irradiation of the radiation is immediately ceased in the case that depression of the switch is released during imaging.

When imaging is initiated, radiation is irradiated from the radiation irradiating section 12 toward the radiation imaging section 15, and obtainment of a radiation image is performed.

Electric charges that bear radiation image information are accumulated as a latent image in the solid state detector 20 when radiation is irradiated thereon. The amount of accumulated latent image electric charges is approximately proportionate to the radiation dosage which has passed through the subject. Therefore, the latent image electric charges bear an electrostatic latent image of the subject.

After a predetermined amount of time elapses, recording onto the solid state detector 20 is ceased, to complete the imaging operation. Thereafter, the solid state detector 20 is caused to output analog signals corresponding to the latent image electric charges. The analog signals are converted into digital signals by the image signal processing section, to generate digital image signals. The generated digital image signals are transmitted from the image signal processing section to the computer 4 via the memory.

When the digital image signals are received from the radiation imaging apparatus 3, the computer 4 causes a preview image of the digital image signals to be displayed on the monitor 5, and the process ends.

In the radiation imaging system 1 of the present embodiment, imaging can be performed not only by using the solid state detector 20 built in to the radiation imaging apparatus 3, but also by using a different means, such as an imaging plate, utilizing only the imaging stage of the apparatus and not the solid state detector 20.

Hereinafter, the procedure for performing such an imaging operation will be described.

When the operator inputs a command indicating that the solid state detector 20 of the apparatus will not be utilized to the computer 4, the computer 4 causes the cam 36 to rotate 180°, thereby moving the detector holder 34 to the standby position.

In this state, it becomes possible to insert a radiation imaging cassette 40 into the imaging position through the cassette insertion opening 31. Note that the radiation image detecting means built in to the radiation imaging cassette 40 may be any device, such as a solid state detector of the type described above and an imaging plate. The operator inserts a cassette suited for the objectives of imaging.

When an imaging operation is initiated, equipment, such as the internal grid 32 and the AEC 33, can be utilized in the case that the radiation imaging cassette 40 is utilized, in a manner similar to the case that the solid state detector 20 is utilized.

A preferred embodiment of the present invention has been described above. However, the present invention is not limited to the above embodiment, and various changes and modifications are possible. For example, the moving mechanism and the direction of movement of the detector holder (solid state detector) may be different from those described in the embodiment.

In addition, a solid state detector of the TFT readout type is utilized in the embodiment described above. Alternatively, a solid state detector of the optical readout type or other types of solid state detectors may be employed.

What is claimed is:

1. A radiation imaging apparatus, comprising:
a casing; and
a solid state detector, for recording radiation images of subjects as electrostatic latent images by receiving irradiation of radiation which has passed through the subjects, housed in a predetermined imaging position within the casing;
the solid state detector being held within the casing so as to be movable from the imaging position to a standby position away from the imaging position; and
the casing being configured to be capable of accepting insertion of a radiation imaging cassette having a radiation image detecting means that obtains radiation images of subjects as by receiving irradiation of radiation which has passed through the subjects at the imaging position, when the solid state detector is at the standby position.

2. A radiation imaging apparatus as defined in claim 1, wherein:
the solid state detector is configured to move so as to separate from a radiation incident surface of the casing to move from the imaging position to the standby position.
